(19) United States
(12) Patent Application Publication
(10) Pub. No.: US 2026/0326837 A1
(43) Pub. Date: Oct. 22, 2026

(54) APPARATUS FOR FACILITATING MOUNTING OF A FIRST OBJECT TO A SECOND OBJECT

(71) Applicant: Brian Lee Hayden, Fillmore, IN (US)

(72) Inventor: Brian Lee Hayden, Fillmore, IN (US)

(21) Appl. No.: 19/395,921

(22) Filed: Nov. 20, 2025

Related U.S. Application Data
(60) Provisional application No. 63/725,345, filed on Nov. 26, 2024.

(51) Int. Cl. B62D 35/00; F16B 7/18

(52) U.S. Cl. CPC B62D 35/005; F16B 7/18

(57) ABSTRACT

The present disclosure provides an apparatus for facilitating mounting of a first object to a second object. Further, the apparatus includes a bolt comprising a bolt head and a bolt shaft, a bolt sleeve comprising a sleeve head, a sleeve shaft, and a sleeve internal cavity configured to allow the bolt shaft to pass, and a nut comprising a nut hole configured to allow a portion of the bolt shaft to pass. Further, the nut is configured to be transitioned from a first orientation to a second orientation in relation to the bolt sleeve. Further, the apparatus includes a mounting component comprising a mounting hole configured to allow the sleeve shaft to pass. Further, the sleeve shaft extending from the mounting hole is received by a first object. Further, the mounting body includes a mounting internal cavity configured to receive a portion of a second object.

### REFERENCE TO RELATED APPLICATIONS

This application claims the benefit of U.S. Provisional Patent Application No. 63/725,345, titled “APPARATUS FOR FACILITATING MOUNTING OF A FIRST OBJECT TO A SECOND OBJECT”, filed on Nov. 26, 2024, which is incorporated by reference herein in its entirety.

### FIELD OF DISCLOSURE

The present disclosure generally relates to tools and hardware. More specifically, the present disclosure relates to an apparatus for facilitating mounting of a first object to a second object.

### BACKGROUND

The present disclosure relates generally to the field of aerodynamic component mounting systems for racing vehicles, and more particularly to systems and apparatuses configured for mounting and replacing front wings on winged sprint cars. The field of competitive motorsports demands continuous technological improvements to ensure performance, safety, and efficiency. Aerodynamic stability and rapid serviceability of aerodynamic components, such as wings, are critical to maintaining race competitiveness and reducing downtime during events. Effective mounting systems not only influence the aerodynamic performance of the vehicle but also affect the structural integrity and maintenance logistics during high-stress racing conditions.

A desirable objective in the disclosed field is to achieve a system that allows rapid replacement and precise reinstallation of damaged aerodynamic components, particularly the front wing of a sprint car, while maintaining structural rigidity, aerodynamic accuracy, and repeatable alignment. Further, the system should minimize weight, simplify mechanical complexity, and withstand repetitive high-load cycles and environmental exposure inherent to dirt-track and sprint racing conditions.

However, existing mounting systems and methods used for sprint car front wings suffer from several limitations. Many known systems rely on multi-point attachments to the frame or chassis, requiring extensive disassembly during replacement and thereby consuming valuable time during a race. Such systems often transmit impact loads directly to the vehicle chassis, leading to structural damage and increased repair complexity.

Moreover, conventional designs typically lack precise reinstallation alignment, causing aerodynamic imbalance after replacement, which may adversely affect vehicle handling. The existing systems also tend to employ bulky or non-aerodynamic hardware that introduces unwanted drag and flow separation at the wing junction, reducing aerodynamic efficiency.

Further challenges arise from the vibration environment and debris exposure associated with sprint racing, which may cause loosening of fasteners, contamination of joints, and premature wear of mounting components. The absence of preload verification, adaptive compliance, or debris-shedding features in conventional designs leads to maintenance unreliability and increased risk of mechanical failure. Additionally, the inability of current systems to accommodate controlled energy dissipation during impacts often results in damage propagation to structural members, including torsion bars and chassis nodes.

Therefore, there is an improved apparatus for facilitating mounting of a first object to a second object that may overcome one or more of the preceding problems

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparatus for facilitating mounting of a first object to a second object. Further, the apparatus may include a bolt comprising a bolt head and a bolt shaft. Further, the bolt shaft extends from a base of the bolt head. Further, the apparatus may include a bolt sleeve comprising a sleeve head and a sleeve shaft.

Further, the sleeve shaft extends from a base of the sleeve head. Further, the bolt sleeve includes a sleeve internal cavity extending through the sleeve head and the sleeve shaft.

Further, the sleeve internal cavity may be configured to allow the bolt shaft to pass through the bolt sleeve. Further, a portion of the bolt shaft extends out from a base of the sleeve shaft. Further, the base of the sleeve shaft may be characterized by a first shape.

Further, the apparatus may include a nut comprising a nut hole. Further, the nut hole may be configured to allow the portion of the bolt shaft to pass through the nut. Further, a base of the nut may be characterized by a second shape. Further, the second shape may be complementary to the first shape. Further, the nut may be configured to be transitioned from a first orientation to a second orientation in relation to the bolt sleeve based on rotating of the bolt. Further, the second orientation of the nut engages the base of the nut with the base of the sleeve shaft. Further, the apparatus may include a mounting component comprising a mounting body and a mounting head. Further, the mounting head includes a mounting hole. Further, the mounting hole may be configured to allow the sleeve shaft to pass through the mounting head. Further, a portion of the sleeve shaft extends from the mounting hole. Further, the portion of the sleeve shaft extending from the mounting hole may be received by a first object. Further, the sleeve head may be configured to be attached to the mounting head. Further, the mounting component may be secured to the bolt sleeve based on transitioning of the nut from the first orientation to the second orientation. Further, the mounting component may be mounted to the first object based on the transitioning of the nut from the first orientation to the second orientation.

Further, the mounting body extending from the mounting head includes a mounting internal cavity. Further, the mounting internal cavity may be configured to receive a portion of a second object. Further, the mounting internal cavity may be configured to attach to the portion of the second object.

The present disclosure provides an apparatus for facilitating mounting of a first object to a second object. Further, the apparatus may include a bolt comprising a bolt head and a bolt shaft. Further, the bolt shaft extends from a base of the bolt head.

Further, the bolt head includes a head and a flange. Further, the head may be configured to be compatible with one or more tools. Further, the one or more tools may be configured to rotate the bolt by rotating the head. Further, the flange may be attached to a base of the head. Further, the bolt shaft extends from a base of the flange. Further, the apparatus may include a bolt sleeve comprising a sleeve head and a sleeve shaft. Further, the sleeve shaft extends from a base of the sleeve head. Further, the bolt sleeve includes a sleeve internal cavity extending through the sleeve head and the sleeve shaft. Further, the sleeve internal cavity may be configured to allow the bolt shaft to pass through the bolt sleeve. Further, a portion of the bolt shaft extends out from a base of the sleeve shaft.

Further, the base of the sleeve shaft may be characterized by a first shape. Further, the apparatus may include a nut comprising a nut hole. Further, the nut hole may be configured to allow the portion of the bolt shaft to pass through the nut. Further, a base of the nut may be characterized by a second shape. Further, the second shape may be complementary to the first shape. Further, the nut may be configured to be transitioned from a first orientation to a second orientation in relation to the bolt sleeve based on rotating of the bolt. Further, the second orientation of the nut engages the base of the nut with the base of the sleeve shaft. Further, the apparatus may include a mounting component comprising a mounting body and a mounting head. Further, the mounting head includes a mounting hole. Further, the mounting hole may be configured to allow the sleeve shaft to pass through the mounting head. Further, a portion of the sleeve shaft extends from the mounting hole. Further, the portion of the sleeve shaft extending from the mounting hole may be received by a first object. Further, the sleeve head may be configured to be attached to mounting head. Further, the mounting component may be secured to the bolt sleeve based on transitioning of the nut from the first orientation to the second orientation. Further, the mounting component may be mounted to the first object based on the transitioning of the nut from the first orientation to the second orientation.

Further, the mounting body extending from the mounting head includes a mounting internal cavity. Further, the mounting internal cavity may be configured to receive a portion of a second object. Further, the mounting internal cavity may be configured to attach to the portion of the second object.

The present disclosure provides an apparatus for facilitating mounting of a first object to a second object. Further, the apparatus may include a bolt comprising a bolt head and a bolt shaft. Further, the bolt shaft extends from a base of the bolt head. Further, the apparatus may include a bolt sleeve comprising a sleeve head and a sleeve shaft.

Further, the sleeve shaft extends from a base of the sleeve head. Further, the bolt sleeve includes a sleeve internal cavity extending through the sleeve head and the sleeve shaft.

Further, the sleeve internal cavity may be configured to allow the bolt shaft to pass through the bolt sleeve. Further, a portion of the bolt shaft extends out from a base of the sleeve shaft. Further, the base of the sleeve shaft may be characterized by a first shape.

Further, the apparatus may include a nut comprising a nut hole. Further, the nut hole may be configured to allow the portion of the bolt shaft to pass through the nut. Further, a base of the nut may be characterized by a second shape. Further, the second shape may be complementary to the first shape. Further, the nut may be configured to be transitioned from a first orientation to a second orientation in relation to the bolt sleeve based on rotating of the bolt in a first direction. Further, the second orientation of the nut engages the base of the nut with the base of the sleeve shaft. Further, the nut may be further configured to be transitioned from the second orientation to the first direction in relation to the bolt sleeve based on rotating of the bolt in a second direction. Further, the first direction may be different from the second direction. Further, the apparatus may include a mounting component comprising a mounting body and a mounting head. Further, the mounting head includes a mounting hole. Further, the mounting hole may be configured to allow the sleeve shaft to pass through the mounting head. Further, a portion of the sleeve shaft extends from the mounting hole. Further, the portion of the sleeve shaft extending from the mounting hole may be received by a first object. Further, the sleeve head may be configured to be attached to mounting head. Further, the mounting component may be secured to the bolt sleeve based on transitioning of the nut from the first orientation to the second orientation. Further, the mounting component may be mounted to the first object based on the transitioning of the nut from the first orientation to the second orientation. Further, the mounting body extending from the mounting head includes a mounting internal cavity. Further, the mounting internal cavity may be configured to receive a portion of a second object. Further, the mounting internal cavity may be configured to attach to the portion of the second object.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an apparatus 100 for facilitating mounting of a first object to a second object, in accordance with some embodiments.

FIG. 2 illustrates a bolt sleeve 110 attached to a bolt 102 of the apparatus 100 for facilitating mounting of a first object to a second object, in accordance with some embodiments.

FIG. 3 illustrates a nut 118 of the apparatus 100 for facilitating mounting of a first object to a second object, in accordance with some embodiments.

FIG. 4 illustrates a bolt sleeve 110 attached to the nut 118 of the apparatus 100 for facilitating mounting of a first object to a second object, in accordance with some embodiments.

FIG. 5 illustrates a mounting component 120 of the apparatus 100 for facilitating mounting of a first object to a second object, in accordance with some embodiments.

FIG. 6 illustrates a perspective view of the mounting component 120 of the apparatus 100 for facilitating mounting of a first object to a second object, in accordance with some embodiments.

FIG. 7 illustrates the apparatus 100 for facilitating mounting of a first object to a second object, in accordance with some embodiments.

FIG. 8 illustrates a second object 802 of the apparatus 100 for facilitating mounting of a first object to a second object, in accordance with some embodiments.

FIG. 9 illustrates the apparatus 100 mounted with a first object 910 and the second object 802, in accordance with some embodiments.

FIG. 10 illustrates the second object 802 of the apparatus 100 for facilitating mounting of a first object to a second object, in accordance with some embodiments.

FIG. 11 illustrates the apparatus 100 secured to the second object 802, in accordance with some embodiments, in accordance with some embodiments.

FIG. 12 illustrates an apparatus 1200 for facilitating mounting of a first object to a second object, in accordance with some embodiments.

FIG. 13 illustrates an apparatus 1300 for facilitating mounting of a first object to a second object, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview

The present disclosure describes a bolt-on wing mount that may be easily removed and replaced in the event of an accident. Winged sprint car racing is growing in popularity and damage to the front wing can easily knock a driver out of a race because the crew may not get the repair made within the allotted time. The bolt-on wing mount may be a quick apply and release front wing mount which may allow teams to replace a front wing quickly and get the driver back on the track to finish the race. The present disclosure describes a design that mounts the front nose wing directly to the torsion bars. Further, the mount may be held on by a bolt flange type of retainer with a ⅜″ bolt.

Further, the bolt-on wing mount solely mounted to the torsion bar alone, wherein other mounts mount to the frame/chassis or the torsion tube.

The present disclosure relates to a quick-apply and quick-release front wing mount for a winged sprint car that may be configured to secure a nose wing directly to a torsion bar and may be removed and replaced rapidly under race conditions. In some embodiments, the mount may be retained by a flange-type retainer actuated by a ⅜-inch bolt and may be characterized by a sole attachment to the torsion bar rather than to a frame, chassis, or torsion tube, thereby providing a distinct load path and simplified serviceability. In some embodiments, the apparatus may include a bolt, a sleeve with an internal cavity, a complementary nut with indexed orientations relative to the sleeve, and a mounting component with a head and body defining a receiving cavity for a wing stand, wherein rotating the bolt may transition the nut between a first and second orientation to selectively clamp or release the assembly.

In some embodiments, a torsion-bar-only attachment architecture may isolate aerodynamic and impact loads from the chassis hard points and may thereby reduce strain energy transmitted into the frame nodes. The technical problem of slow repairs and secondary damage from conventional frame-or torsion-tube-mounted brackets may be addressed by constraining the load path to the torsion bar spline or surface using a keyed sleeve head and a complementary mounting head shape that may resist rotation about the torsion bar axis while permitting axial assembly.

In some embodiments, the keyed interface may be implemented by non-circular polygons such as hex, Double-D, or spline profiles, by serrated radial teeth with a defined pressure angle, or by eccentric lobes that may self-center under clamp load.

In some embodiments, the keyed faces may be ground to a surface roughness of Ra ≤0.8 μm and may include nitride case layers of 0.2-0.4 mm to maintain anti-galling performance under repeated pit-lane cycles. The technology improved may be vehicle aero-structural mounting systems for sprint cars, specifically the interface between aerodynamic components and suspension torsion members.

In some embodiments, a bi-stable orientation index of the nut and sleeve that may convert a small angular rotation of the bolt into a predictable axial clamp or release stroke with tactile feedback. The technical problem of over-or under-tightening during fast service may be addressed by forming complementary first and second shapes on opposing bases of the sleeve and nut, wherein the nut may transition between discrete detent orientations as the bolt is rotated.

In some embodiments, the detent may be achieved by cam ramps with dwell regions, by wave-spring-biased lobes engaging shallow pockets, or by a polygonal bayonet interface having quarter-turn engagement to full clamp. In some embodiments, the bolt head may be compatible with common paddock tools and may present a captive washer stack that may maintain preload as the nut crosses detents, thereby preventing loss of parts during service. The technology improved may be quick-release mechanical fastening mechanisms suitable for motorsport environments.

In some embodiments, a sacrificial shear-and-slide fuse embedded in the mounting component that may fracture in a controlled manner upon predetermined impact vectors, allowing the wing to separate without bending the torsion bar or deforming the sleeve. The technical problem of collision-induced torsion bar or chassis damage may be addressed by defining a reduced section in the mounting body around the mounting internal cavity and by orienting anisotropic fibers or lattices to favor failure along a plane orthogonal to the bar axis.

In some embodiments, the fuse may be implemented as a replaceable 3D-printed metallic or composite insert with a calibrated notch radius, as a stacked lamination with interleaf adhesive tailored for Mode II shear delamination, or as a dual-material bimetal zone where yield offsets occur at a known clamp load, improving an energy-management for aero-mount structures.

In some embodiments, a self-indexing alignment and datum scheme that may return the wing stand to a repeatable pitch, yaw, and roll within ±0.2° after every swap, thereby minimizing aerodynamic balance drift. The technical problem of inconsistent reinstallation geometry may be addressed by pairing conical lead-ins on the sleeve shaft with tri-lobe kinematic locators in the mounting head and by encoding datum flats on the stand that may cooperate with spring-biased detents in the mounting internal cavity.

In some embodiments, hardened steel or ceramic locating pads may be co-planarized through lapping, and the datum may be measured against a portable jig with magnetic reference pins for pit-lane verification. The technology improved may be repeatable aero-mount kinematics and alignment in racing applications.

In some embodiments, a low-profile flange retainer and sleeve geometry that may minimize frontal area and unsteady separation at the wing-stand junction, leading to improved local Reynolds number behavior and reduced buffeting under yaw. The technical problem of drag and flow separation induced by bulky clamp hardware may be addressed by shaping the flange as a filleted toroid blended into the sleeve head with a curvature-continuous profile and by recessing the bolt head flush with the flange crown.

In some embodiments, the flange may be machined as an integral head on the bolt or may be realized as a separate ring with a tapered interference fit onto the bolt head, and the exterior may be glass-bead finished to a matte texture to mitigate boundary-layer transition irregularities, improving aerodynamic integration of mechanical fasteners.

In some embodiments, material-tailored compliance within the sleeve shaft and mounting head that may attenuate high-frequency loads from track chatter, thereby maintaining clamp preload on the ⅜-inch fastener. The technical problem of preload loss due to micro-slip and fretting may be addressed by incorporating thin compliant interlayers such as cold-spray aluminum-bronze, plasma-sprayed ceramic-metal cermet, or laser-textured dimples that may increase effective joint damping without compromising stiffness under static aero loads.

In some embodiments, the sleeve internal cavity may be selectively threaded or surface-treated to match the threaded shaft pitch lead error and to reduce torque scatter across repeated cycles. The technology improved may be vibration-robust bolted joints in motorsport assemblies.

In some embodiments, a contamination-tolerant, debris-shedding groove architecture on exterior nut surfaces and on the mounting body that may maintain grip and tool engagement when exposed to clay or dust. The technical problem of tool slippage and ingress during pit-lane service may be addressed by radial channels with self-clearing helical paths, by hydrophobic or oleophobic coatings such as fluoropolymer-based layers, and by drainage apertures that may vent particulate under centrifugal acceleration during bolt rotation. The technology improved may be reliability of service interfaces under off-road debris conditions.

In some embodiments, a smart preload verification feature may be integrated using a washer that may include a miniature strain bridge or magnetoelastic sensor that may telemeter clamp load to a handheld reader, thereby addressing the problem of uncertain torque-to-tension correlation during hurried pit-stops. In some embodiments, the washer may be a foil-gauged Belleville with temperature compensation, or a magnetoelastic ring whose Barkhausen noise signature may be mapped to axial strain, or a capacitive gap sensor embedded under the flange that may report collapse distance, thereby improving the technology of on-vehicle fastening diagnostics.

In some embodiments, an anti-rotation micro-clutch may be included between the sleeve head and mounting head that may allow limited relative rotation under transient lateral impacts while preserving axial clamp. The technical problem of torsion bar shock spikes may be addressed by a dry-film-lubricated ramp-and-roller clutch with ±3° stroke, by a miniature elastomeric Oldham coupling keyed to datum flats, or by a thin-pack wave spring that may yield at a calibrated torque, thereby improving torsional overload resilience in aero-mount interfaces.

In some embodiments, a corrosion-segregation stack may be employed to prevent galvanic coupling between dissimilar materials in wet dirt-track environments. The technical problem of accelerated corrosion at mixed aluminum/steel joints may be addressed by introducing a dielectric sleeve liner, by applying micro-arc oxidation to aluminum mounting heads, or by using zinc-nickel sacrificial platings on the bolt sleeve coupled with epoxy primers on adjacent aluminum, thereby improving longevity of mixed-metal motorsport joints.

In some embodiments, a topology-optimized lattice infill within the mounting body may be used to maximize specific energy absorption while maintaining stiffness at the kinematic datums. The technical problem of weight penalties from conventional solid blocks may be addressed by additive manufacturing of graded lattices with anisotropic unit cells, by selective hot-isostatic pressing of high-stress regions, or by hybrid builds where wrought faces at datum pads may be friction-stir welded onto additively manufactured cores, thereby improving mass-efficient crashworthiness of wing mounts.

In some embodiments, a tool-less actuation option may be provided by a fold-flat lever integrated with the bolt head that may cam over the flange retainer to generate the same axial clamp as a socketed head, with a secondary lock pin to meet sanctioning safety rules. The technical problem of dependency on specific tools during a timed caution may be addressed by a lever with a compound cam profile and a hidden torsion spring housed within the flange, by a detent-pin quick pin that may only release when the lever is at the full-open angle, or by a recessed finger-grip head with glove-friendly scallops, thereby improving human-factors performance in pit-stop operations.

In some embodiments, a surface-encoded reinstallation guide may be included via laser-etched fiducials on the mounting head that may be readable by low-cost AR glasses used by the crew to confirm that pitch and yaw fall within tolerance after a swap. The technical problem of inconsistent visual alignment on dimly lit pit lanes may be addressed by printing high-contrast fiducials registered to the kinematic datums, by including a reflective microprism inlay to enhance detectability, or by embedding a passive NFC tag that may store calibration offset data, thereby improving augmented-reality assisted alignment for rapid aero setup.

In some embodiments, a dust-exclusion shutter may be integrated into the mounting internal cavity that may remain closed when the wing stand is removed and may auto-retract when the stand is reinserted, thereby keeping the receiving cavity clean. The technical problem of debris-induced misalignment may be addressed by a spring-steel iris shutter with PTFE liners, by a silicone bellows with memory shape that may invert on insertion, or by a hinged flap biased by a torsion micro-spring, thereby improving environmental sealing of precision datum features.

In some embodiments, the above features may be combined with the bolt-sleeve-nut architecture in which the bolt shaft may pass through the sleeve internal cavity and a portion of the shaft may extend beyond the sleeve to engage a nut configured to transition between indexed orientations relative to the sleeve based on rotation of the bolt, while a mounting component with a head and body may receive a portion of a wing mounting stand for detachable attachment to a torsion bar of a sprint car.

In some embodiments, the bolt shaft may be threaded and of approximately ⅜-inch diameter, the sleeve cavity may be threaded or smooth depending on preload strategy, the sleeve head and mounting head may include complementary shapes configured to resist rotatory movement, the nut exterior surface may include grooves to provide enhanced grip during service, and the mounting body may define holes aligned with a wing-stand hole to receive coupling elements.

In some embodiments, the manufacturing approach may be tailored to operational priorities. In some embodiments, components subject to wear may be composed of steel or steel alloys for endurance, while weight-critical members of the mounting body may include aluminum alloys with hard-coat anodization; in other embodiments, titanium alloy sleeves may be used for high specific strength, and composites may be co-cured onto metallic inserts at the kinematic pads to provide a thermal barrier against brake heat radiated toward the torsion bar. In some embodiments, the entire assembly may be configured to be swapped within a single caution period without chassis jacking by virtue of the axial insertion path, self-indexing datum, and bi-stable clamp action that may reduce the number of tool actions to one continuous rotation or a single lever cam-over.

In some embodiments, the improvements may collectively advance the technology of sprint-car aerodynamic mounting by providing a torsion-bar-centric load path with predictable failure modes, rapid and repeatable service operations, improved vibrational robustness, reduced aerodynamic penalty at the fastener interface, and integrated verification of clamp state, thereby enabling teams to replace a damaged front wing and return to competition without compromising structural integrity or vehicle balance.

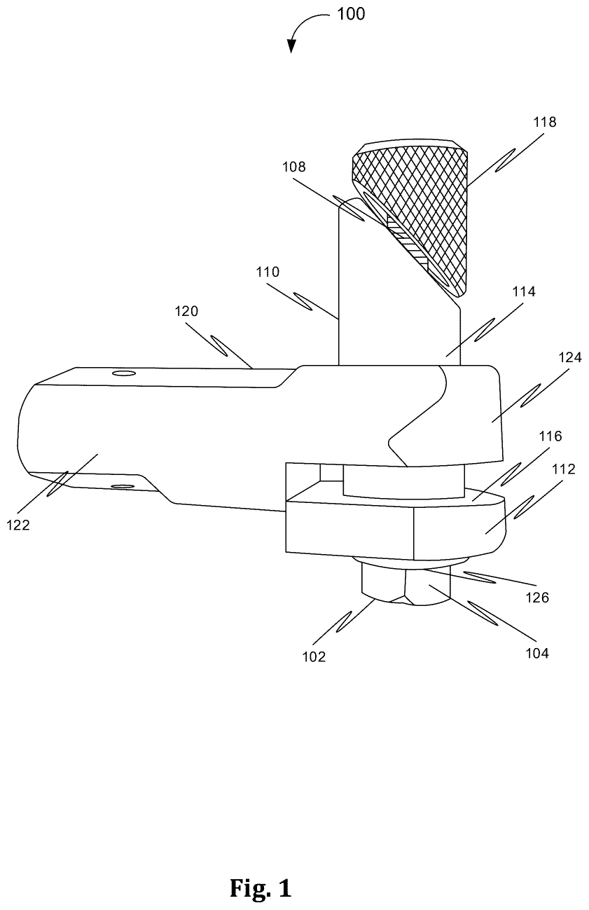

FIG. 1 illustrates an apparatus 100 for facilitating mounting of a first object 910 to a second object, in accordance with some embodiments. Further, the apparatus 100 may include a bolt 102 comprising a bolt head 104 and a bolt shaft 108. Further, the bolt shaft 108 extends from a base of the bolt head 126. Further, the apparatus 100 may include a bolt sleeve 110 comprising a sleeve head 112 and a sleeve shaft 114. Further, the sleeve shaft 114 extends from a base of the sleeve head 116. Further, the bolt sleeve 110 includes a sleeve internal cavity 202 extending through the sleeve head 112 and the sleeve shaft 114. Further, the sleeve internal cavity 202 may be configured to allow the bolt shaft 108 to pass through the bolt sleeve 110. Further, a portion of the bolt shaft 108 extends out from a base of the sleeve shaft 204. Further, the base of the sleeve shaft 204 may be characterized by a first shape. Further, the apparatus 100 may include a nut 118 comprising a nut hole 302. Further, the nut hole 302 may be configured to allow the portion of the bolt shaft 108 to pass through the nut 118. Further, a base of the nut 304 may be characterized by a second shape. Further, the second shape may be complementary to the first shape. Further, the nut 118 may be configured to be transitioned from a first orientation 404 to a second orientation 402 in relation to the bolt sleeve 110 based on rotating of the bolt 102. Further, the second orientation 402 of the nut 118 engages the base of the nut 304 with the base of the sleeve shaft 204. Further, the apparatus 100 may include a mounting component 120 comprising a mounting body 122 and a mounting head 124. Further, the mounting head 124 includes a mounting hole 502. Further, the mounting hole 502 may be configured to allow the sleeve shaft 114 to pass through the mounting head 124. Further, a portion of the sleeve shaft 114 extends from the mounting hole 502. Further, the portion of the sleeve shaft 114 extending from the mounting hole 502 may be received by a first object 910. Further, the sleeve head 112 may be configured to be attached to mounting head 124. Further, the mounting component 120 may be secured to the bolt sleeve 110 based on transitioning of the nut 118 from the first orientation 404 to the second orientation 402. Further, the mounting component 120 may be mounted to the first object 910 based on the transitioning of the nut 118 from the first orientation 404 to the second orientation 402. Further, the mounting body 122 extending from the mounting head 124 includes a mounting internal cavity 504. Further, the mounting internal cavity 504 may be configured to receive a portion of a second object 802. Further, the mounting internal cavity 504 may be configured to attach to the portion of the second object 802.

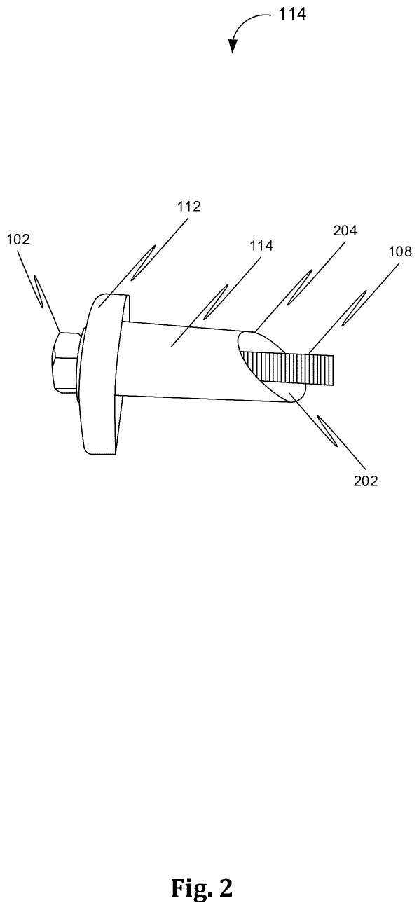

FIG. 2 illustrates a bolt sleeve 110 attached to a bolt 102 of the apparatus 100 for facilitating mounting of a first object to a second object, in accordance with some embodiments. Further, the bolt shaft 108 may pass through the sleeve internal cavity 202.

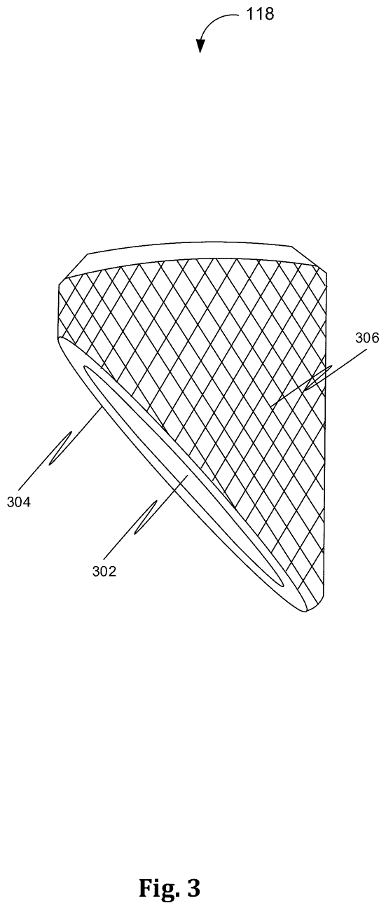

FIG. 3 illustrates the nut 118 of the apparatus 100 for facilitating mounting of a first object to a second object, in accordance with some embodiments. Further, the nut 118 includes an exterior surface comprising two or more grooves 306. Further, the two or more grooves 306 provide a grip between the first object 910 and the apparatus 100.

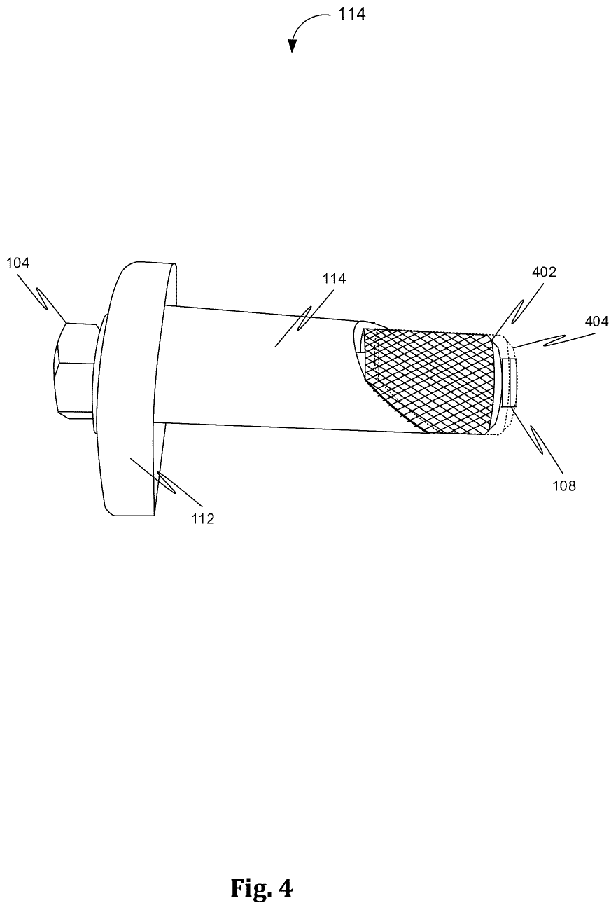

FIG. 4 illustrates a bolt sleeve 110 attached to the nut 118 of the apparatus 100 for facilitating mounting of a first object to a second object, in accordance with some embodiments. Further, FIG. 4 illustrates the first orientation 404 of the nut 118 and the second orientation 402 of the nut 118.

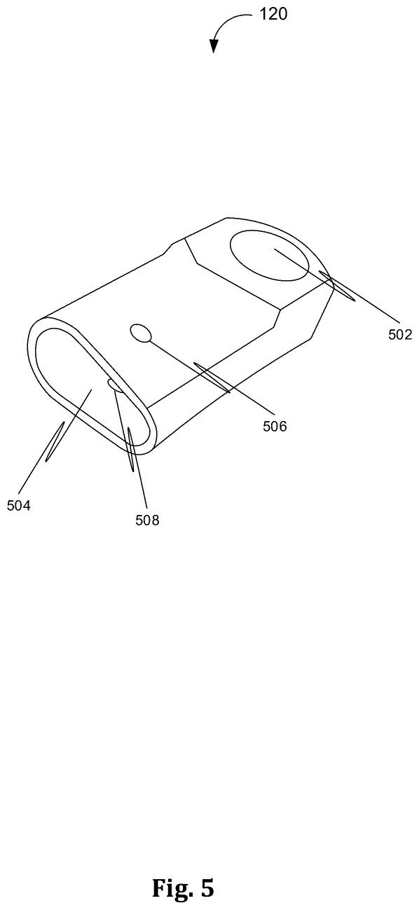

FIG. 5 illustrates the mounting component 120 of the apparatus 100 for facilitating mounting of a first object to a second object, in accordance with some embodiments.

Further, the mounting body 122 includes two or more holes (506 and 508). Further, the two or more holes (506 and 508) include a first hole 506 on a first side 702 of the mounting body 122 and a second hole 508 on a second side 704 of the mounting body 122. Further, a position of the second hole 508 on the second side 704 may be in line with a position of the first hole 506 on the first side 702.

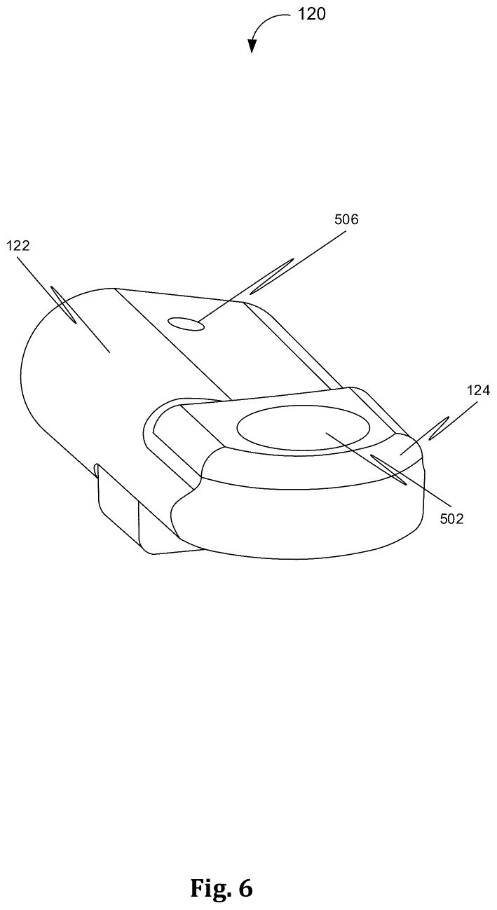

FIG. 6 illustrates a perspective view of the mounting component 120 of the apparatus 100 for facilitating mounting of a first object to a second object, in accordance with some embodiments. Further, the perspective view of the mounting component 120 shows the first hole 506 and the mounting hole 502.

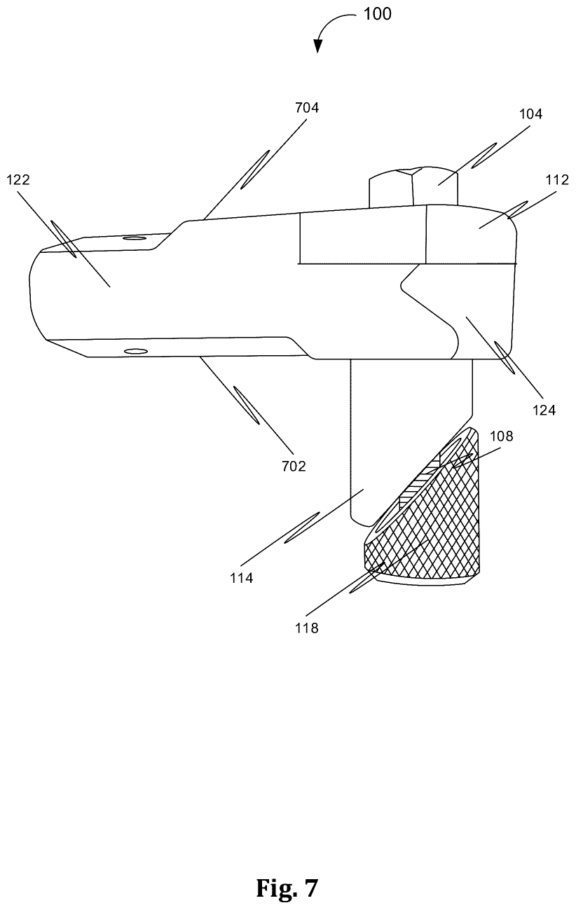

FIG. 7 illustrates the apparatus 100 for facilitating mounting of a first object to a second object, in accordance with some embodiments. Further, FIG. 7 shows the first side 702 of the mounting component 120 and the second side 704 of the mounting component 120.

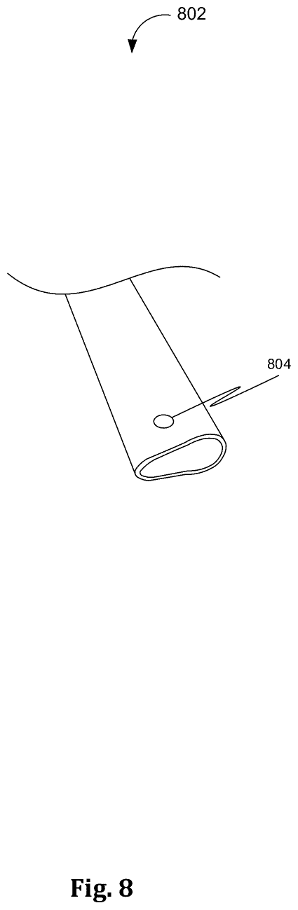

FIG. 8 illustrates a second object 802 of the apparatus 100 for facilitating mounting of a first object to a second object, in accordance with some embodiments.

Further, the portion of the second object 802 includes a second object hole 804. Further, the second object hole 804 may be aligned with the two or more holes (506 and 508) of the mounting component 120 after the receiving of the portion of the second object 802. Further, the two or more holes (506 and 508) and the second object hole 804 may be configured to receive one or more coupling elements 902 which may be configured to secure the second object 802 with the mounting block 120.

In some embodiments, the rotating of the bolt 102 includes rotating the bolt 102 in a first direction. Further, the transitioning of the nut 118 from the first orientation 404 to the second orientation 402 may be based on the rotating of the bolt 102 in a first direction.

In some embodiments, the nut 118 may be further configured to be transitioned from the second orientation 402 to the first direction 404 in relation to the bolt sleeve 110 based on rotating of the bolt 102 in a second direction. Further, the first direction may be different from the second direction.

In some embodiments, the first orientation 404 of the nut 118 allows a movement of the bolt sleeve 110 in relation to the mounting component 120.

In some embodiments, the bolt head 104 may be configured to be compatible with one or more tools. Further, the one or more tools may be configured to rotate the bolt 102 by rotating the bolt head 104. Further, the rotating of the bolt 102 includes rotating the bolt 102 using the one or more tools.

In some embodiments, the bolt head 104 includes a head 904 and a flange 906.

Further, the head 904 may be configured to be compatible with one or more tools.

Further, the one or more tools may be configured to rotate the bolt 102 by rotating the head 904. Further, the rotating of the bolt 102 includes rotating the bolt 102 using the one or more tools. Further, the flange 906 may be attached to a base of the head 904. Further, the bolt shaft 108 extends from a base of the flange 908.

In some embodiments, the sleeve head 112 may be configured to be attached to the mounting head 124 for restricting a rotatory movement of the mounting component 120 in relation to the sleeve shaft 114.

In some embodiments, the sleeve head 112 may be characterized by a sleeve head shape. Further, the mounting head 124 may be characterized by a mounting head shape. Further, the mounting head shape may be complementary to the sleeve head shape to facilitate the restricting of the rotatory movement of the mounting component 120 in relation to the sleeve shaft 114.

In some embodiments, one or more of the bolt sleeve 110, the nut 118, and the mounting component 120 may be composed of a metallic material.

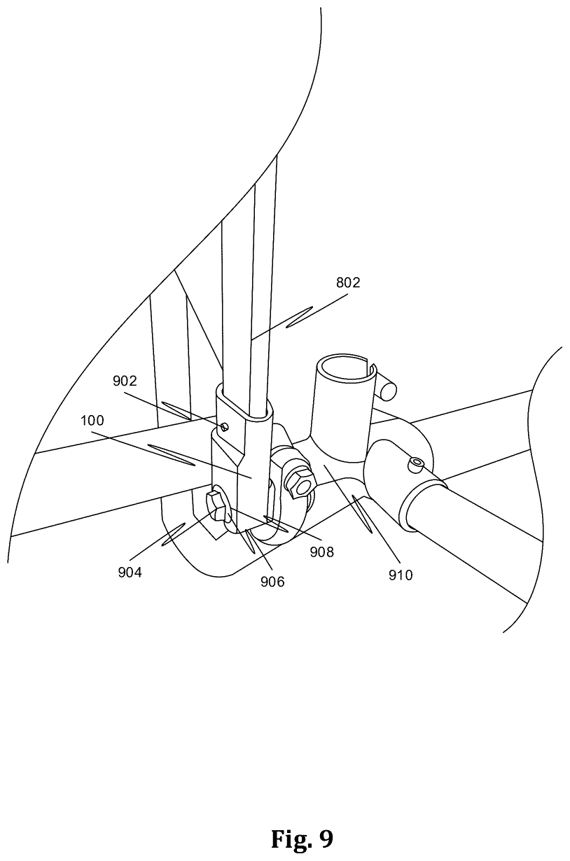

FIG. 9 illustrates the apparatus 100 mounted with the first object 910 and the second object 802, in accordance with some embodiments. Further, the first object 910 includes a torsion tube of a vehicle. Further, the second object 802 includes a wing mounting stand.

In some embodiments, the mounting internal cavity 504 may be configured to detachably attach to the portion of the second object 802.

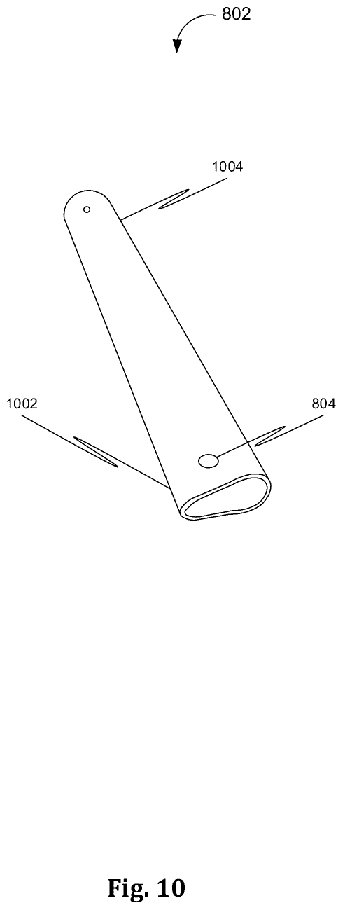

FIG. 10 illustrates the second object 802 of the apparatus 100 for facilitating mounting of a first object to a second object, in accordance with some embodiments.

Further, the second object 802 extends between a first end 1002 and a second end 1004. Further, the first end 1002 of the second object 802 includes the portion of the second object 802. Further, the second end 1004 of the second object 802 may be configured to be attached to an additional object.

In some embodiments, the second orientation 402 includes two or more second orientations. Further, the transitioning of the nut 118 from the first orientation 404 to the second orientation 402 includes transitioning of the nut 118 from the first orientation 404 to one or more of the two or more second orientations based on the rotating of the bolt 102.

In some embodiments, the portion of the second object 802 may be characterized by a first set of dimensions. Further, the mounting internal cavity 504 may be characterized by a second set of dimensions which may be configured to facilitate an insertion of the portion of the second object 802 into the mounting internal cavity 504.

Further, the receiving of the portion of the second object 802 may be based on the insertion of the portion of the second object 802 into the mounting internal cavity 504.

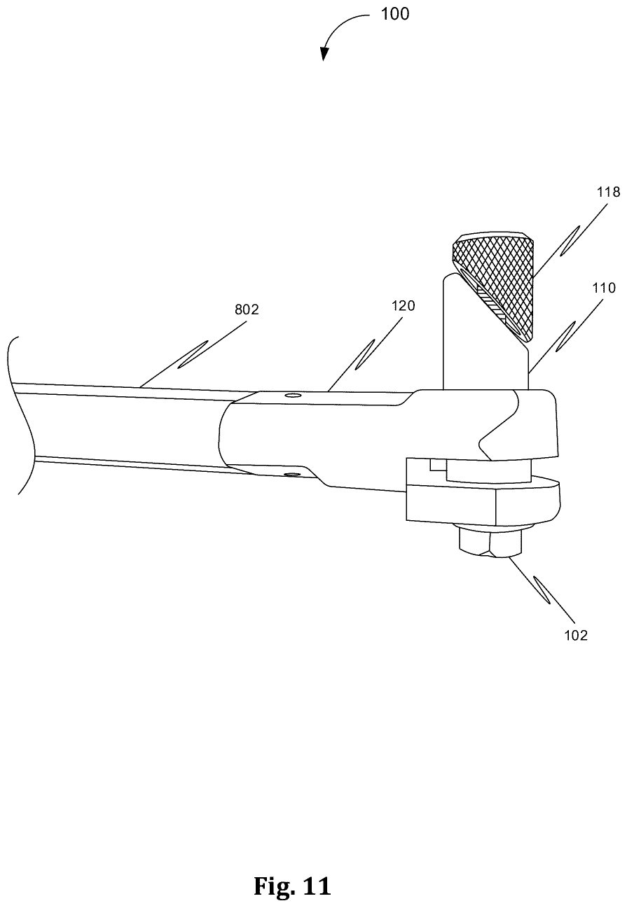

FIG. 11 illustrates the apparatus 100 secured to the second object 802, in accordance with some embodiments, in accordance with some embodiments. Further, FIG. 11 shows the mounting head 120, the nut 118, the bolt 102, the bolt sleeve 110, and the mounting component 120 of the apparatus 100.

In some embodiments, the head 904 includes a hexagonal head.

In some embodiments, the bolt shaft 108 includes a threaded shaft.

In some embodiments, the sleeve internal cavity 202 may be characterized by a threaded surface.

In some embodiments, the flange may be characterized by a circular shape.

In some embodiments, one or more of the bolt sleeve 110, the nut 118, and the mounting component 120 may be composed of at least one an aluminum element, an iron element, a steel element, and an alloy element.

In some embodiments, the second object 802 includes an automotive airfoil.

Further, the first object 910 includes a vehicle.

In some embodiments, the additional object includes the automotive airfoil.

Further, the second object 802 includes a wing mounting stand.

In some embodiments, the vehicle includes a sprint car.

In some embodiments, the additional object includes one of a top wing of the sprint car and a nose wing of the sprint car.

In some embodiments, the bolt shaft 108 may be characterized by a diameter of 3/8 inch.

In some embodiments, the one or more coupling elements includes one of a rivet and an additional bolt.

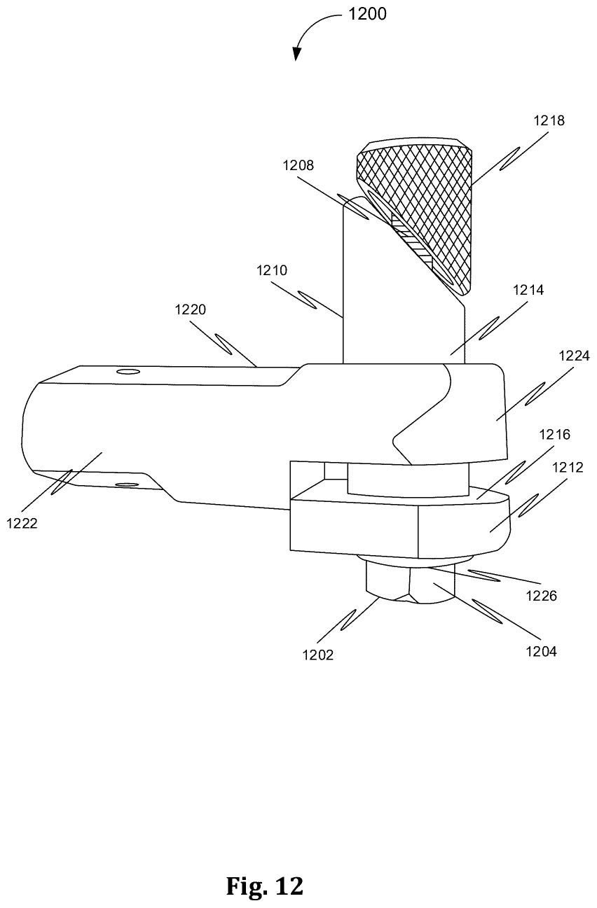

FIG. 12 illustrates an apparatus 1200 for facilitating mounting of a first object to a second object, in accordance with some embodiments. Further, the apparatus 1200 may include a bolt 1202 comprising a bolt head 1204 and a bolt shaft 1208. Further, the bolt head 1204 may include a head and a flange. Further, the head may be configured to be compatible with one or more tools. Further, the one or more tools may be configured to rotate the bolt by rotating the head. Further, the flange may be attached to a base of the head. Further, the bolt shaft 1208 extends from a base of the flange. Further, the apparatus 1200 may include a bolt sleeve 1210 comprising a sleeve head 1212 and a sleeve shaft 1214. Further, the sleeve shaft 1214 extends from a base of the sleeve head 1216. Further, the bolt sleeve 1210 includes a sleeve internal cavity extending through the sleeve head 1212 and the sleeve shaft 1214. Further, the sleeve internal cavity may be configured to allow the bolt shaft 1208 to pass through the bolt sleeve 1210. Further, a portion of the bolt shaft 1208 extends out from a base of the sleeve shaft. Further, the base of the sleeve shaft may be characterized by a first shape. Further, the apparatus 1200 may include a nut 1218 comprising a nut hole. Further, the nut hole may be configured to allow the portion of the bolt shaft 1208 to pass through the nut 1218. Further, a base of the nut may be characterized by a second shape. Further, the second shape may be complementary to the first shape. Further, the nut 1218 may be configured to be transitioned from a first orientation to a second orientation in relation to the bolt sleeve 1210 based on rotating of the bolt 1202. Further, the second orientation of the nut 1218 engages the base of the nut with the base of the sleeve shaft. Further, the apparatus 1200 may include a mounting component 1220 comprising a mounting body 1222 and a mounting head 1224. Further, the mounting head 1224 includes a mounting hole. Further, the mounting hole may be configured to allow the sleeve shaft 1214 to pass through the mounting head 1224. Further, a portion of the sleeve shaft 1214 extends from the mounting hole. Further, the portion of the sleeve shaft 1214 extending from the mounting hole may be received by a first object. Further, the sleeve head 1212 may be configured to be attached to mounting head 1224. Further, the mounting component 1220 may be secured to the bolt sleeve 1210 based on transitioning of the nut 1218 from the first orientation to the second orientation. Further, the mounting component 1220 may be mounted to the first object based on the transitioning of the nut 1218 from the first orientation to the second orientation. Further, the mounting body 1222 extending from the mounting head 1224 includes a mounting internal cavity. Further, the mounting internal cavity may be configured to receive a portion of a second object. Further, the mounting internal cavity may be configured to attach to the portion of the second object.

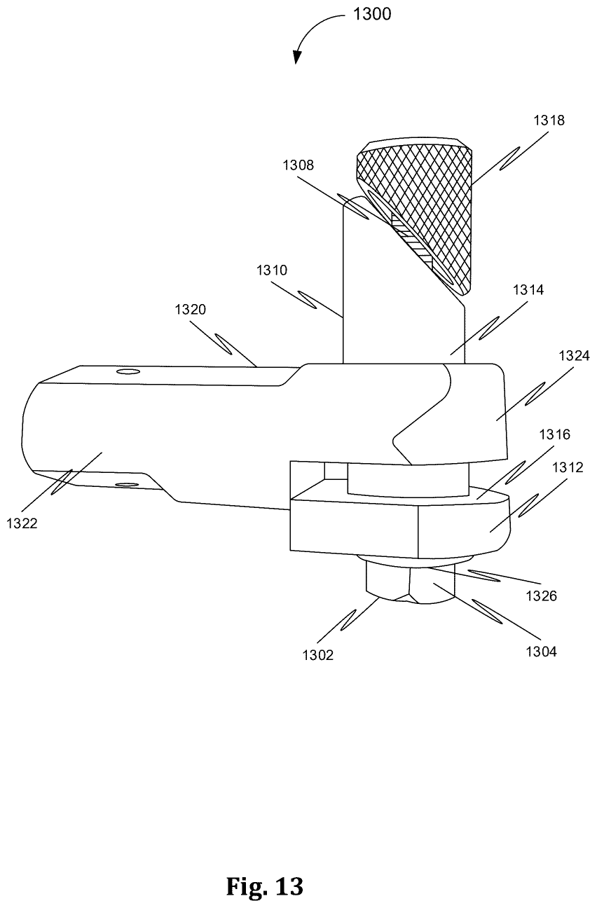

FIG. 13 illustrates an apparatus 1300 for facilitating mounting of a first object to a second object, in accordance with some embodiments. Further, the apparatus 1300 may include a bolt 1302 comprising a bolt head 1304 and a bolt shaft 1308. Further, the bolt shaft 1308 extends from a base of the bolt head 1304. Further, the apparatus 1300 may include a bolt sleeve 1310 comprising a sleeve head 1313 and a sleeve shaft 1314.

Further, the sleeve shaft 1314 extends from a base of the sleeve head 1316. Further, the bolt sleeve 1310 includes a sleeve internal cavity extending through the sleeve head 1312 and the sleeve shaft 1314. Further, the sleeve internal cavity may be configured to allow the bolt shaft 1308 to pass through the bolt sleeve 1310. Further, a portion of the bolt shaft 1308 extends out from a base of the sleeve shaft. Further, the base of the sleeve shaft may be characterized by a first shape. Further, the apparatus 1300 may include a nut 1318 comprising a nut hole. Further, the nut hole may be configured to allow the portion of the bolt shaft 1308 to pass through the nut 1318. Further, a base of the nut may be characterized by a second shape. Further, the second shape may be complementary to the first shape. Further, the nut 1318 may be configured to be transitioned from a first orientation to a second orientation in relation to the bolt sleeve 1310 based on a rotating of the bolt 1302 in a first direction. Further, the second orientation of the nut 1318 engages the base of the nut with the base of the sleeve shaft. Further, the nut 1318 may be further configured to be transitioned from the second orientation to the first direction in relation to the bolt sleeve 1310 based on rotating of the bolt 1302 in a second direction.

Further, the first direction may be different from the second direction. Further, the second orientation of the nut 1318 engages the base of the nut with the base of the sleeve shaft. Further, the apparatus 1300 may include a mounting component 1320 comprising a mounting body 1322 and a mounting head 1324. Further, the mounting head 1324 includes a mounting hole. Further, the mounting hole may be configured to allow the sleeve shaft 1314 to pass through the mounting head 1324. Further, a portion of the sleeve shaft 1314 extends from the mounting hole. Further, the portion of the sleeve shaft 1314 extending from the mounting hole may be received by a first object. Further, the sleeve head 1312 may be configured to be attached to mounting head 1324. Further, the mounting component 1320 may be secured to the bolt sleeve 1310 based on transitioning of the nut 1318 from the first orientation to the second orientation. Further, the mounting component 1320 may be mounted to the first object based on the transitioning of the nut 1318 from the first orientation to the second orientation. Further, the mounting body 1322 extending from the mounting head 1324 includes a mounting internal cavity. Further, the mounting internal cavity may be configured to receive a portion of a second object.

Further, the mounting internal cavity may be configured to attach to the portion of the second object.

Although the invention has been explained in relation to its preferred embodiment, it is to be understood that many other possible modifications and variations can be made without departing from the spirit and scope of the invention as hereinafter claimed.

What is claimed is:

1. An apparatus for facilitating mounting of a first object to a second object, the apparatus comprising:
a bolt comprising a bolt head and a bolt shaft, wherein the bolt shaft extends from a base of the bolt head;
a bolt sleeve comprising a sleeve head and a sleeve shaft, wherein the sleeve shaft extends from a base of the sleeve head, wherein the bolt sleeve comprises a sleeve internal cavity extending through the sleeve head and the sleeve shaft, wherein the sleeve internal cavity is configured to allow the bolt shaft to pass through the bolt sleeve, wherein a portion of the bolt shaft extends out from a base of the sleeve shaft, wherein the base of the sleeve shaft is characterized by a first shape;
a nut comprising a nut hole, wherein the nut hole is configured to allow the portion of the bolt shaft to pass through the nut, wherein a base of the nut is characterized by a second shape, wherein the second shape is complementary to the first shape, wherein the nut is configured to be transitioned from a first orientation to a second orientation in relation to the bolt sleeve based on a rotating of the bolt, wherein the second orientation of the nut engages the base of the nut with the base of the sleeve shaft; and
a mounting component comprising a mounting body and a mounting head, wherein the mounting head comprises a mounting hole, wherein the mounting hole is configured to allow the sleeve shaft to pass through the mounting head, wherein a portion of the sleeve shaft extends from the mounting hole, wherein the portion of the sleeve shaft extending from the mounting hole is received by a first object, wherein the sleeve head is configured to be attached to mounting head, wherein the mounting component is secured to the bolt sleeve based on transitioning of the nut from the first orientation to the second orientation, wherein the mounting component is mounted to the first object based on the transitioning of the nut from the first orientation to the second orientation, wherein the mounting body extending from the mounting head comprises a mounting internal cavity, wherein the mounting internal cavity is configured to receive a portion of a second object, wherein the mounting internal cavity is configured to attach to the portion of the second object.

2. The apparatus of claim 1, wherein the nut comprises an exterior surface comprising a plurality of grooves, wherein the plurality of grooves provides a grip between the first object and the apparatus.

3. The apparatus of claim 1, wherein the mounting body comprises a plurality of holes, wherein the plurality of holes comprises a first hole on a first side of the mounting body and a second hole on a second side of the mounting body, wherein a position of the second hole on the second side is in line with a position of the first hole on the first side.

4. The apparatus of claim 3, wherein the portion of the second object comprises a second object hole, wherein the second object hole is aligned with the plurality of holes of the mounting component after the receiving of the portion of the second object, wherein the plurality of holes and the second object hole are configured to receive at least one coupling element configured to secure the second object with the mounting block.

5. The apparatus of claim 1, wherein the rotating of the bolt comprises rotating the bolt in a first direction, wherein the transitioning of the nut from the first orientation to the second orientation is based on the rotating of the bolt in a first direction.

6. The apparatus of claim 5, wherein the nut is further configured to be transitioned from the second orientation to the first direction in relation to the bolt sleeve based on rotating of the bolt in a second direction, wherein the first direction is different from the second direction.

7. The apparatus of claim 1, wherein the first orientation of the nut allows a movement of the bolt sleeve in relation to the mounting component.

8. The apparatus of claim 1, wherein the bolt head is configured to be compatible with at least one tool, wherein the at least one tool is configured to rotate the bolt by rotating the bolt head, wherein the rotating of the bolt comprises rotating the bolt using the at least one tool.

9. The apparatus of claim 1, wherein the bolt head comprises a head and a flange, wherein the head is configured to be compatible with at least one tool, wherein the at least one tool is configured to rotate the bolt by rotating with the head, wherein the rotating of the bolt comprises rotating the bolt using the at least one tool, wherein the flange is attached to a base of the head, wherein the bolt shaft extends from a base of the flange.

10. The apparatus of claim 1, wherein the sleeve head is configured to be attached to the mounting head for restricting a rotatory movement of the mounting component in relation to the sleeve shaft.

11. The apparatus of claim 10, wherein the sleeve head is characterized by a sleeve head shape, wherein the mounting head is characterized by a mounting head shape, wherein the mounting head shape is complementary to the sleeve head shape to facilitate the restricting of the rotatory movement of the mounting component in relation to the sleeve shaft.

12. The apparatus of claim 1, wherein at least one of the bolt sleeve, the nut, and the mounting component is composed of a metallic material.

13. The apparatus of claim 1, wherein the second object extends between a first end and a second end, wherein the first end of the second object comprises the portion of the second object, wherein the second end of the second object is configured to be attached to an additional object.

14. The apparatus of claim 1, wherein the first object comprises a torsion tube of a vehicle, wherein the second object comprises a wing mounting stand.

15. The apparatus of claim 1, wherein the mounting internal cavity is configured to detachably attach to the portion of the second object.

16. The apparatus of claim 1, wherein the second orientation comprises a plurality of second orientations, wherein the transitioning of the nut from the first orientation to the second orientation comprises transitioning of the nut from the first orientation to at least one of the plurality of second orientations based on the rotating of the bolt.

17. The apparatus of claim 13, wherein the portion of the second object is characterized by a first set of dimensions, wherein the mounting internal cavity is characterized by a second set of dimensions configured to facilitate an insertion of the portion of the second object into the mounting internal cavity, wherein the receiving of the portion of the second object is based on the insertion of the portion of the second object into the mounting internal cavity.

18. The apparatus of claim 9, wherein the head comprises a hexagonal head.

19. An apparatus for facilitating mounting of a first object to a second object, the apparatus comprising:
a bolt comprising a bolt head and a bolt shaft, wherein the bolt head comprises a head and a flange, wherein the head is configured to be compatible with at least one tool, wherein the at least one tool is configured to rotate the bolt by rotating the head, wherein the flange is attached to a base of the head, wherein the bolt shaft extends from a base of the flange;
a bolt sleeve comprising a sleeve head and a sleeve shaft, wherein the sleeve shaft extends from a base of the sleeve head, wherein the bolt sleeve comprises a sleeve internal cavity extending through the sleeve head and the sleeve shaft, wherein the sleeve internal cavity is configured to allow the bolt shaft to pass through the bolt sleeve, wherein a portion of the bolt shaft extends out from a base of the sleeve shaft, wherein the base of the sleeve shaft is characterized by a first shape;
a nut comprising a nut hole, wherein the nut hole is configured to allow the portion of the bolt shaft to pass through the nut, wherein a base of the nut is characterized by a second shape, wherein the second shape is complementary to the first shape, wherein the nut is configured to be transitioned from a first orientation to a second orientation in relation to the bolt sleeve based on a rotating of the bolt, wherein the second orientation of the nut engages the base of the nut with the base of the sleeve shaft; and
a mounting component comprising a mounting body and a mounting head, wherein the mounting head comprises a mounting hole, wherein the mounting hole is configured to allow the sleeve shaft to pass through the mounting head, wherein a portion of the sleeve shaft extends from the mounting hole, wherein the portion of the sleeve shaft extending from the mounting hole is received by a first object, wherein the sleeve head is configured to be attached to mounting head, wherein the mounting component is secured to the bolt sleeve based on transitioning of the nut from the first orientation to the second orientation, wherein the mounting component is mounted to the first object based on the transitioning of the nut from the first orientation to the second orientation, wherein the mounting body extending from the mounting head comprises a mounting internal cavity, wherein the mounting internal cavity is configured to receive a portion of a second object, wherein the mounting internal cavity is configured to attach to the portion of the second object.

20. An apparatus for facilitating mounting of a first object to a second object, the apparatus comprising:
a bolt comprising a bolt head and a bolt shaft, wherein the bolt shaft extends from a base of the bolt head;
a bolt sleeve comprising a sleeve head and a sleeve shaft, wherein the sleeve shaft extends from a base of the sleeve head, wherein the bolt sleeve comprises a sleeve internal cavity extending through the sleeve head and the sleeve shaft, wherein the sleeve internal cavity is configured to allow the bolt shaft to pass through the bolt sleeve, wherein a portion of the bolt shaft extends out from a base of the sleeve shaft, wherein the base of the sleeve shaft is characterized by a first shape;
a nut comprising a nut hole, wherein the nut hole is configured to allow the portion of the bolt shaft to pass through the nut, wherein a base of the nut is characterized by a second shape, wherein the second shape is complementary to the first shape, wherein the nut is configured to be transitioned from a first orientation to a second orientation in relation to the bolt sleeve based on a rotating of the bolt in a first direction, wherein the second orientation of the nut engages the base of the nut with the base of the sleeve shaft, wherein the nut is further configured to be transitioned from the second orientation to the first direction in relation to the bolt sleeve based on rotating of the bolt in a second direction, wherein the first direction is different from the second direction; and
a mounting component comprising a mounting body and a mounting head, wherein the mounting head comprises a mounting hole, wherein the mounting hole is configured to allow the sleeve shaft to pass through the mounting head, wherein a portion of the sleeve shaft extends from the mounting hole, wherein the portion of the sleeve shaft extending from the mounting hole is received by a first object, wherein the sleeve head is configured to be attached to mounting head, wherein the mounting component is secured to the bolt sleeve based on transitioning of the nut from the first orientation to the second orientation, wherein the mounting component is mounted to the first object based on the transitioning of the nut from the first orientation to the second orientation, wherein the mounting body extending from the mounting head comprises a mounting internal cavity, wherein the mounting internal cavity is configured to receive a portion of a second object, wherein the mounting internal cavity is configured to attach to the portion of the second object.
